(19) United States
(12) Patent Application Publication
(10) Pub. No.: US 2006/0176387 A1
(43) Pub. Date: Aug. 10, 2006

(54) Image-taking apparatus

(75) Inventor: Koji Kobayashi, Asaka (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/342,656

(22) Filed: Jan. 31, 2006

(30) Foreign Application Priority Data
Feb. 7, 2005 (JP) 2005-030577

(51) Int. Cl. H04N 5/222

(52) U.S. Cl. 348/333.01

(57) ABSTRACT

The present invention relates to an image-taking apparatus such as a digital camera or camera phone which is equipped with a release button and shoots a still image when the release button is pressed and equipped with capabilities to reduce the possibility of missing photo opportunities. The image-taking apparatus has a first live view generating mode which generates and displays a live view at a first frame rate and a second live view generating mode which generates and displays a live view at a second frame rate faster than the first live view generating mode.

### BACKGROUND OF THE INVENTION

1. Field of the Invention

The present invention relates to an image-taking apparatus such as a digital camera or camera phone which is equipped with a release button and shoots a still image when the release button is pressed.

2. Description of the Related Art

Recently, instead of conventional film-based cameras, digital cameras which obtain image data of subjects focused onto an image pickup element such as a CCD image pickup element as well as cell phones equipped with such a digital camera have come into wide use. Hereinafter, such cameras will be collectively or representatively referred to as digital cameras.

One of the problems with digital cameras is a time lag between aphotographer's shooting action and actual shooting. Many of commercially available digital cameras have large time lags, often resulting in missed photo opportunities.

To reduce such time lags, Japanese Patent Publication No. 2-30633 and Japanese Patent Publication No. 2-30634 disclose techniques for exposure control of still-image shooting using results of metering for movie shooting by omitting newly doing metering for still-image shooting upon switching from movie shooting to still-image shooting (AE)

For example, the proposals made by Japanese Patent Publication No. 2-30633 and Japanese Patent Publication No. 2-30634 are intended to reduce the time required to get ready to actually shoot a still image upon switching from movie shooting to still-image shooting. That is, in a camera equipped, for example, with a two-step type release button which lends itself to a half press and full press, after a half press which switches the camera from a live view (through image) display in which moving images are displayed to still-image shooting mode, the proposals intend to reduce the time required for the camera to get ready to perform a sequence to perform actual still-image shooting by a full press when the still-image shooting preparation has been completed from a half press timing.

Although it is important to reduce the time lag, there is another important time delay which must be reduced in order not to miss photo opportunities. Cameras typically display a live view again when preparations for still-image shooting are completed after a half press. If there is ample time between the half press and full press, the user may full-press the release button by checking a field angle on a live view displayed again after the half press and subsequent completion of the preparations for still-image shooting. However, although the user intended to full press the release button by checking the field angle determined finally based on the live view, it can happen that a moving subject displayed at the center of the final field angle is actually shot in a corner of the still image or, in the worse case, gets out of the image. This is attributable to the fact that there is a time lag between the time when an image pickup element takes an image for live view display and the time when the image is actually displayed and that the live view currently being displayed is a thing of the past.

### SUMMARY OF THE INVENTION

The present invention has been made in view of the above circumstances and provides an image-taking apparatus equipped with capabilities to reduce the possibility of missing photo opportunities.

The present invention provides an image-taking apparatus which is equipped with a release button and shoots a still image when the release button is pressed, wherein:

the release button is a two-step type which lends itself to a half press and full press; and

the image-taking apparatus has: a live view generating section which generates and displays a live view, which is moving images for display, in a half-pressed state after metering for a still image and measurement of distance; and a shooting section which shoots a still image in response to a full press; and

the live view generating section has a first live view generating mode which generates and displays a live view at a first frame rate and a second live view generating mode which generates and displays a live view at a second frame rate faster than the first frame rate.

Preferably the first live view generating mode generates a live view at a frame rate equivalent to 50 ms/frame.

The image-taking apparatus according to the present invention has a second live view generating mode which generates and displays a live view at a fast frame rate. This mode displays a live view with a reduced time lag, making it possible to obtain a still image with a reduced deviation in a field angle from that confirmed in the live view.

If the first live view generating mode generates a live view at a frame rate equivalent to 50 ms/frame, flickering is prevented during shooting under an electric light operating on 50-Hz or 60-Hz commercial power, making it possible to select, according to scenes, whether to give priority to flicker prevention or photo opportunities.

### BRIEF DESCRIPTION OF THE DRAWINGS

FIG. 1 is an external perspective view of a digital camera which is an embodiment of an image-taking apparatus according to the present invention, as viewed obliquely from the upper front;

FIG. 2 is a block diagram showing a circuit configuration of the digital camera shown in FIG. 1;

FIG. 3 is a diagram showing a typical shooting sequence of the digital camera shown in FIGS. 1 and 2;

FIG. 4 is a diagram showing a live view sequence after an S1 press when the quick shooting mode is off;

FIG. 5 is a diagram showing a live view sequence after an S1 press when the quick shooting mode is on;

FIG. 6 is a program chart of a live view after an S1 press when the quick shooting mode is off; and

FIG. 7 is a program chart of a live view after an S1 press when the quick shooting mode is on.

### DETAILED DESCRIPTION OF THE INVENTION

An embodiment of the present invention will be described below.

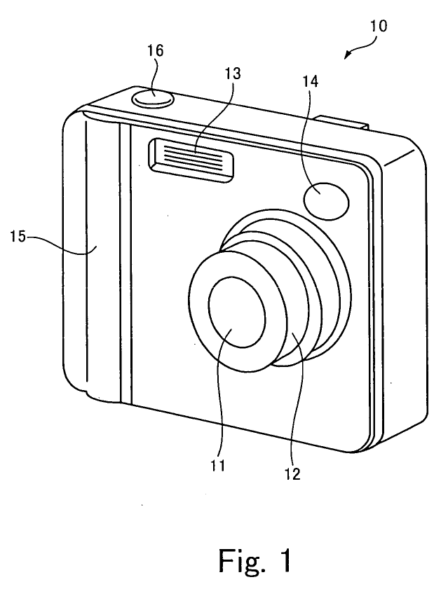

FIG. 1 is an external perspective view of a digital camera which is an embodiment of an image-taking apparatus according to the present invention, as viewed obliquely from the upper front.

At the center in the front face of the digital camera 10 shown in FIG. 1, there is a zoom lens barrel 12 which contains an image taking lens 11 including an optical zoom lens. On an upper front part of the digital camera 10, there are a flash unit 13 which emits a flash in sync with a shot and an optical finder's objective window 14.

Also, on the left front face of the digital camera 10, there is a slide-type power switch 15.

Furthermore, on the top face of the digital camera 10, there is a release button 16.

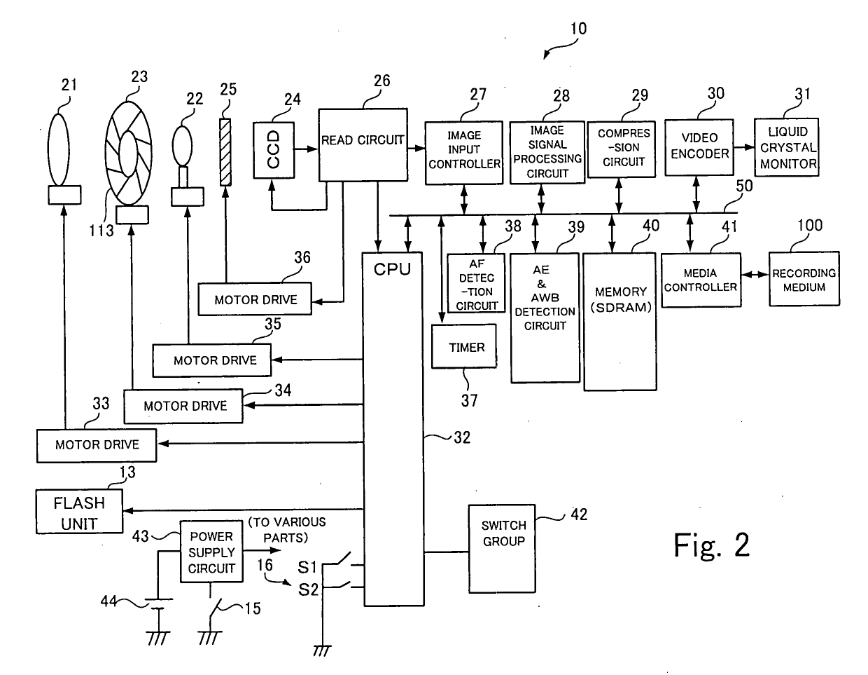

FIG. 2 is a block diagram showing a circuit configuration of the digital camera shown in FIG. 1.

The digital camera 10 is equipped with a zoom lens 21 and focus lens 22 which compose the image taking lens 11, an iris 23 which allows stepwise adjustment of the aperture, a CCD image pickup element (hereinafter referred to as the “CCD”) 24 which receives a subject image formed through the image taking lens (zoom lens 21 and focus lens 22) and iris 23 and generates an analog signal, and a mechanical shutter 25 which limits the length of time during which the CCD 24 is exposed to subject light entering through the image taking lens 11 and iris 23.

Also, the digital camera 10 is equipped with a read circuit 26 consisting of a timing generator which controls timings such as electronic-shutter timing of the CCD 24 and read timing of an image signal and an A/D converter circuit which converts an analog signal read out of the CCD 24 into a digital image signal. The digital camera 10 is also equipped with an image input controller 27 which transmits the digital image signal from the read circuit 26 to a busline 50, and an image signal processing circuit 28 which converts the digital image signal inputted via the busline 50 into a YC signal represented by luminance (Y) and color (C).

Furthermore, the digital camera 10 is equipped with a compression circuit 29 which compresses the YC signal inputted via the busline 50 and a video encoder 30 which converts the YC signal inputted via the busline 50 into an NTSC (National TV Standards Committee) signal. The NTSC signal outputted from the video encoder 30 is supplied to a liquid crystal monitor (hereinafter referred to as the “LCD”) 31 to display images on the LCD 31.

Also, the digital camera 10 is equipped with a CPU 32 which controls the entire digital camera 10; motor drives 33 to 36 which drive the zoom lens 21, iris 23, focus lens 22, and mechanical shutter 25, respectively; and switches S1 and S2 which are turned on at the press of the release button 16 shown in FIG. 1. One (S1) of the two switches S1 and S2 is turned on when the release button 16 is half-pressed while the other switch S2 is turned on when the release button 16 is full-pressed. Hereinafter the state in which the release button 16 is half-pressed will be referred to as an “S1 state” and the state brought about when the release button 16 is full-pressed will be referred to as an “S2 state.” Besides, the state in which the digital camera 10 is in a shooting mode with the power on but the release button 16 is not pressed yet will be referred to as an “S0 state.”

Furthermore, the digital camera 10 is equipped with a timer 37 for use to count various types of time, an AF detection circuit 38 which detects an in-focus position by sensing contrast based on the digital image signal, an AE & AWB detection circuit 39 which detects field luminance and white balance based on the digital image signal, a memory (SDRAM) 40 which temporarily stores the digital image signal, and a media controller 41 which records the image signal compressed by the compression circuit 29 in a portable recording medium 100.

Furthermore, the digital camera 10 is equipped with a switch group 42 consisting of various switches for use to switch between a shooting mode for taking a shot when the release button 16 is pressed and a playback mode for reading taken images stored on the recording medium 100 from the recording medium 100 and further displaying them on the liquid crystal monitor 31, to switch among various shooting modes, to change sensitivity, and to extend the zoom lens; the power switch 15 also shown in FIG. 1; a power supply circuit 43 which supplies power to various parts, being controlled by on/off operations of the power switch 15; a battery 44 which serves as a power source to supply power to the power supply circuit 43; and the flash unit 13 (also shown in FIG. 1) which emits a flash in sync with a shot.

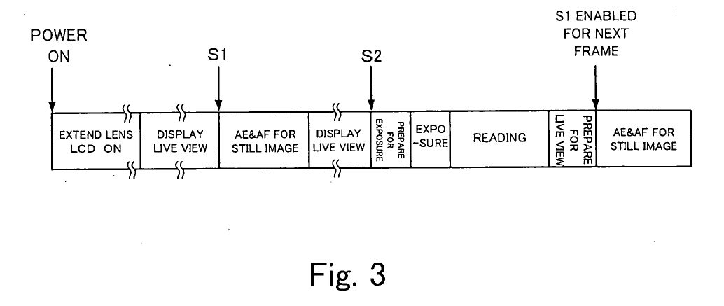

FIG. 3 is a diagram showing a typical shooting sequence of the digital camera shown in FIGS. 1 and 2.

When the power is turned on (ON), the image taking lens is extended and LCD 31 (see FIG. 2) is turned on to display a live view which is moving images for display. Subsequently, when the release button is half-pressed, bringing about the S1 state, metering is performed to determine an exposure for a still image (AE) and an in-focus position is detected (AF). When the AE and AF are finished, the live view is displayed again. In this state, when the release button is full-pressed (bringing about the S2 state), the read circuit 26 shown in the block diagram of FIG. 2 makes preparations for an exposure such as converting a timing clock to be supplied to the CCD 24 into a timing clock for a still image. Upon completion of the preparations, an exposure is made. Subsequently, the image signal is read out of the CCD 24, and then preparations for live view display are made including converting the timing clock to be supplied to the CCD 24 into a timing clock for the live view. Then the release button is ready to be pressed for a next shot.

With a typical shooting sequence, the user half-presses the release button to take a shot (the S1 state), checks scenes as it is using a live view, and full-presses the release button the instant a desired scene is obtained. However, since the scene checked via the live view is a thing of the past, the still image actually obtained may deviate from the desired scene. To deal with this situation, a digital camera according to this embodiment provides a quick shooting mode.

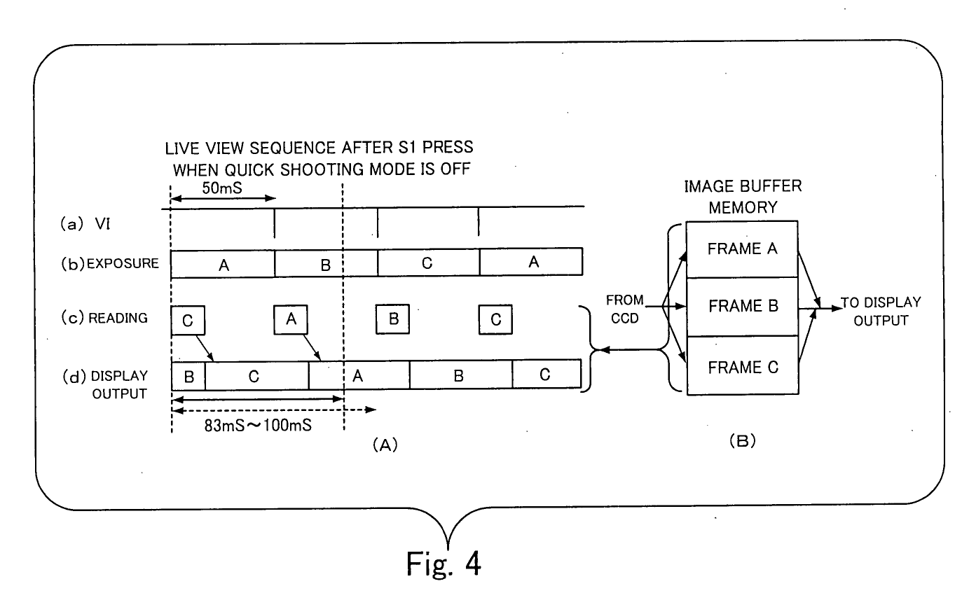

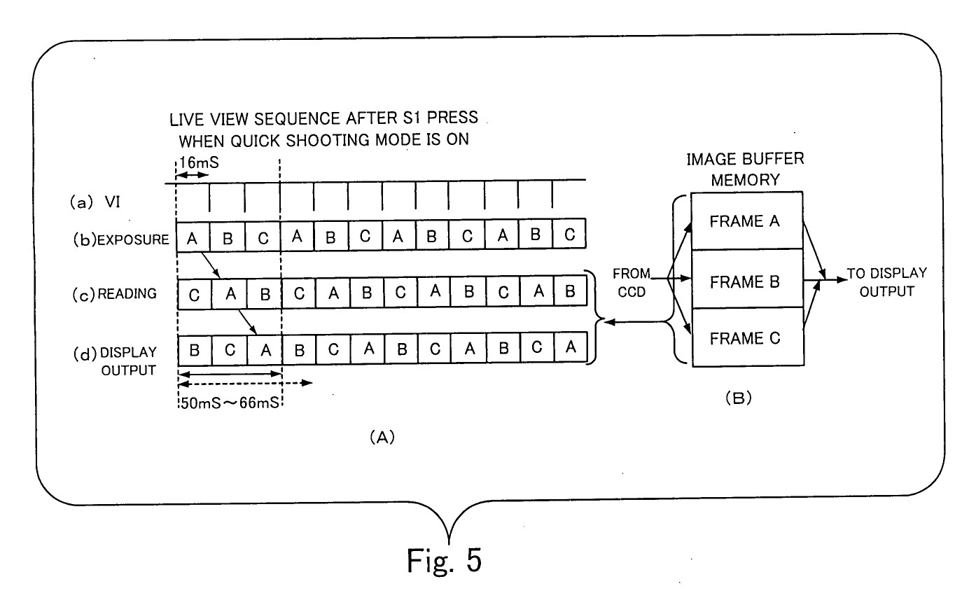

FIG. 4 is a diagram showing a live view sequence after an S1 press when the quick shooting mode is off while FIG. 5 is a diagram showing a live view sequence after an S1 press when the quick shooting mode is on.

Part (A)-(a) of FIG. 4 shows a vertical synchronization signal, where an interval (50 ms, in this case) between adjacent pulses corresponds to a duration of each frame. Thus, the frame rate is 20 frames/second.

The sequence consists of performing an exposure in sync with the vertical synchronization signal (b), reading from a CCD (c), and outputting a live view for display (d). To output the live view for display, as shown in Part (B) of FIG. 4, an image signal for the live view is stored and read out cyclically on a frame-by-frame basis using three frames of image buffer memory prepared in advance.

In FIG. 4 where the live view sequence is performed after an S1 press when the quick shooting mode is off, since the duration of each frame is 50 ms, during shooting under an electric lamp or fluorescent lamp operating on either of 50-Hz commercial power and 60-Hz commercial power, repeated variations in the light quantity of the electric lamp or fluorescent lamp are prevented from causing flickers in the live view, but the time lag before live view display is somewhere around 83 ms to 100 ms.

On the other hand, when the quick shooting mode is on, the duration of each frame is reduced to 16 ms (frame rate is increased to 60 frames/second) as shown in Part (A) of FIG. 5, and consequently the time lag before live view display is reduced to somewhere around 50 ms to 66 ms, accordingly reducing the possibility of missing photo opportunities.

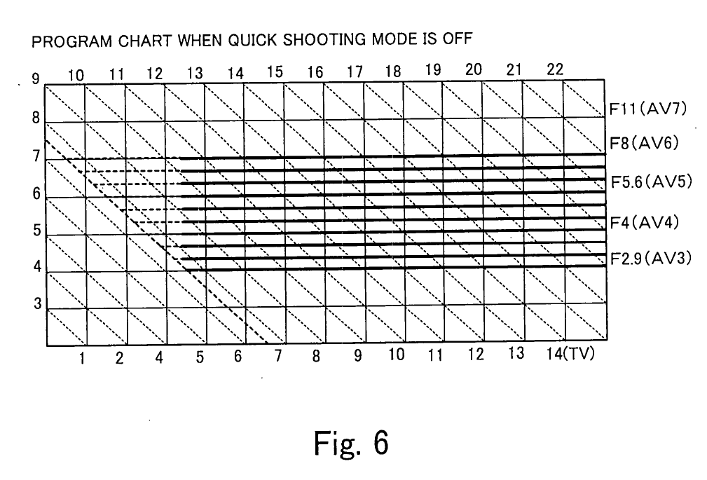

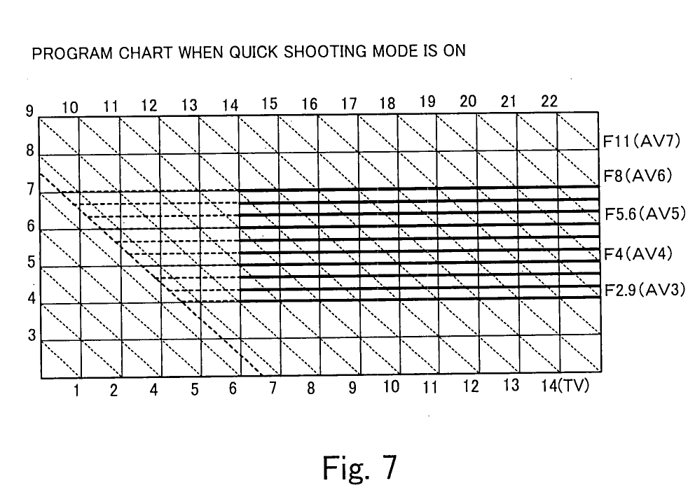

FIG. 6 is a program chart of a live view after an S1 press when the quick shooting mode is off and FIG. 7 is a program chart of a live view after an S1 press when the quick shooting mode is on.

When the quick shooting mode is off as shown in FIG. 6, once an f-stop is selected, the electronic shutter can be set to any shutter speed from the highest shutter speed to TV 4.5 to suit the selected f-stop. However, since the duration of each frame is 50 ms as shown in FIG. 4, an exposure longer than TV 4.5 is not available. Thus, when a shutter time slower than TV 4.5 is needed to accommodate a darker field of view, the shutter time itself is set to TV 4.5 and sensitivity is increased (by increasing the gain of an amplifier which amplifies an image signal read out of the CCD) in zones where the quantity of light is insufficient (indicated by broken lines in FIG. 6). This makes it possible to display a live view at a proper brightness in an exposure range down to EV 7.5.

On the other hand, when the quick shooting mode is on as shown in FIG. 7, since the duration of each frame is as short as 16 ms (the frame rate is as high as 60 frames/second), only shutter times (exposure times) not slower than TV 6 are available. Thus, when a shutter time slower than TV 6 is needed, the shutter second time itself is set to TV 6 and sensitivity is increased (by increasing the gain of an amplifier which amplifies an image signal read out of the CCD) in zones where the quantity of light is insufficient (indicated by broken lines in FIG. 7). This makes it possible to display a live view at a proper brightness in an exposure range down to EV 7.5.

When the situation in which the quick shooting mode is on is compared with the situation in which the quick shooting mode is off, under the situation in which the quick shooting mode is on, the possibility of missing photo opportunities is reduced, but no flicker correction is made, and the live view is more prone to noise due to amplifier gain increase because larger zones are dependent on amplifier gains.

However, the quick shooting mode is intended for outdoor scenes such as athletic meeting scenes where it is not desired to miss photo opportunities. Since shots are taken outdoors rather than under lighting which causes flickers, there is no flickering from the beginning, and thus anti-flicker measures are unnecessary. Also, since shots are taken outdoors where it is relatively bright, there is no need to rely on amplifier gains, and thus there is less of a problem in this respect as well.

From the above point of view, this embodiment provides a quick shooting mode to reduce the possibility of missing photo opportunities.

Although a digital camera which has the appearance shown in FIG. 1 has been described above, the present invention is applicable not only to photographic apparatus which have an appearance of a “camera,” but also, for example, to camera-equipped cell phones and the like.

What is claimed is:

1. An image-taking apparatus which is equipped with a release button and shoots a still image when the release button is pressed, wherein:
the release button is a two-step type which lends itself to a half press and full press; and
the image-taking apparatus comprises: a live view generating section which generates and displays a live view, which is moving images for display, in a half-pressed state after metering for a still image and measurement of distance; and a shooting section which shoots a still image in response to a full press; and
the live view generating section has a first live view generating mode which generates and displays a live view at a first frame rate and a second live view generating mode which generates and displays a live view at a second frame rate faster than the first flame rate.

2. The image-taking apparatus according to claim 1, wherein the first live view generating mode generates a live view at a frame rate equivalent to 50 ms/frame.
